(19) United States
(12) Patent Application Publication
(10) Pub. No.: US 2011/0125784 A1
(43) Pub. Date: May 26, 2011

(54) PLAYBACK OF SYNCHRONIZED MEDIA ARCHIVES AUGMENTED WITH USER NOTES

(75) Inventors: THEODORE CLARKE COCHEU, Aptos, CA (US); Michael F. Prorock, Raleigh, NC (US); Thomas J. Prorock, Raleigh, NC (US)

(73) Assignee: Altus Learning Systems, Inc., Campbell, CA (US)

(21) Appl. No.: 12/954,156

(22) Filed: Nov. 24, 2010

Related U.S. Application Data
(60) Provisional application No. 61/264,595, filed on Nov. 25, 2009.

(51) Int. Cl. G06F 17/30

(52) U.S. Cl. 707/769; 707/E17.014

(57) ABSTRACT

Systems and methods allow collaboration based on media archive based systems. Collaboration events are processed within media archive based systems. End user collaborations are improved and the overall content of the original media archive is enhanced. The collaborative content is modified via the addition of user notes and targeted user notes. User notes can comprise one or more media resources, media archive, or other form of computer readable data. Media resources of user notes are synchronized with the media resources of the media archive. Users can request playback of portions of the media archive. The requested portions of the media archive are presented to the requestor along with user notes associated with positions within the requested portion. Portions of the media archive can be redacted and withheld from presentation to a set of users.

### CROSS REFERENCES TO RELATED APPLICATIONS

This application claims the benefit of U.S. Provisional Application No. 61/264,595, filed Nov. 25, 2009, which is incorporated by reference in its entirety.

### BACKGROUND

1. Field of Art

The disclosure generally relates to the field of collaboration between users of media archive resources, and more specifically, to augmenting a synchronized media archive with another media archive.

2. Description of the Field of Art

The production of audio and video has resulted in many different formats and standards in which to store and/or transmit the audio and video media. The media industry has further developed to encompass other unique types of media production such as teleconferencing, web conferencing, video conferencing, podcasts, other proprietary forms of innovative collaborative conferencing, various forms of collaborative learning systems, and the like. When recorded, for later playback or for archival purposes, all of these forms of media are digitized and archived on some form of storage medium. The goal for many of these products is to provide solutions that optimize and enhance end user collaboration. For example, media archive based solutions are used for learning systems.

Existing media archive based learning systems primarily capture a single event at a given point in time and thus the scope of the knowledge transfer is limited to this single event. A preponderance of end user tools are available for assisting with knowledge development and knowledge transfer, such as blogs, wikis, bookmarks, mashups, and other well known internet based systems. These solutions are not tightly integrated with the original source of the knowledge transfer. They act as reference points to a singular knowledge event. Existing learning systems provide “islands” of knowledge that exist asynchronously from the original captured and recorded knowledge event.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 is an embodiment of a system environment that illustrates the interactions of the main system components of a media archive processing solution, namely the universal media convertor (LNG), universal media format (UMF), and the universal media aggregator (UMA).

FIG. 2 is an embodiment of a system architecture that illustrates the UMA system and related programming modules and services including the collaborative event service.

FIG. 3 is an embodiment of a process illustrating the steps for processing different types of collaboration events.

FIG. 4 is an embodiment of a process illustrating the concept of the dynamically formed collaboration networks that are formed via user federations.

FIG. 5 is an embodiment of a process illustrating the playback of a media archive with integrated types of user notes.

FIG. 6 illustrates an embodiment of the storage format of collaboration events in the UMF.

FIG. 7 illustrates one embodiment of components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Existing attempts at providing collaborative solutions for media archives do not provide a comprehensive and cohesive knowledge transfer solution in which collaboration events are synchronously integrated with the contents of media archives. Disclosed are systems and methods for providing collaborations for media archive based systems solutions. Media archive based systems provide a cohesive framework to process raw media input, provide any required media production services, provide the management of the processed content (including search, data analytics, reporting services, etc.), and provide the synchronous playback of the processed archive resources. The framework for media archive processing provides unified access to, and modification of, media archive resources. Embodiments allow modification of processed media archive solutions in a way that facilitates end user collaborations to improve, and enhance, the overall content of the original media archive.

Systems and methods allow playback of information stored as a media archive. A request for playback of a portion of a media archive is received. The media archive comprises a plurality of media resources as well as a plurality of user notes, each user note associated with a media resource. A first media resource of the media archive is correlated to a second media resource of the media archive. The correlation of the media resources is performed by identifying sequences of patterns in each media resource and correlating elements of the sequences. A first position of the first media archive and a second position of the second media archive are identified such that the two positions are correlated with each other. Positions of two media resources are correlated if they are associated with correlated elements of sequences of the two media resources. The playback of the media archive is performed by presenting the two media resources simultaneously, starting with the positions identified. A user note is presented during the playback if the user note is associated with a position of one of the media resources after the start position for the corresponding media resource.

In an embodiment, a start position as well as an end position is identified for the media resources. The playback is performed of the portion of the media resources between the start and the end positions. Filter criteria can be specified for filtering the user notes. For example, user notes presented during the playback can be filtered to be the user notes added by a particular user, user notes added during a particular time interval, user notes comprising a particular search term, or user notes added by a user associated with a geographical region.

A portion of a media archive starting from a particular position can be extracted and stored as an extracted media archive. The portions of media resources added to the extracted media archive are determined as described for the playback of a portion of media archive. User notes may be stored along with the extracted media archive if they are associated with portions of media resources extracted from the media archive. The user notes stored with the extracted media archive can be filtered based on various criteria. The extracted media archive can be sent in a message to one or more users. Alternatively, the extracted media archive may be stored and the information identifying the stored media archive sent to users.

In an embodiment, portions of the mea archive can be redacted from presentation to all users, a selected set of users, or a specific category of users. For example, a portion of the media archive between a start position and an end position can be redacted. The start position and the end position of the media archive are associated with corresponding positions in the media resources based on synchronization of the media resources. If the portion of the media archive is redacted for a specific set of users, any user belonging to the set is denied access to the information in the redacted portion.

Additional description of the functionality of each of these above mentioned system components is detailed herein. Media archive based systems are described in U.S. Provisional Application No. 61/264,595, filed Nov. 25, 2009, which is incorporated by reference in its entirety. Synchronization of media resources in a media archives is disclosed in the U.S. application Ser. No. 12/755,064 filed on May 6, 2010, which is incorporated by reference in its entirety. Systems and methods for error correction of synchronized media resources are disclosed in the U.S. application Ser. No. 12/875,088 filed on Sep. 2, 2010, which is incorporated by reference in its entirety. Systems and methods for auto-transcription by cross-referencing synchronized media resources are disclosed in the U.S. application Ser. No. 12/894,557 filed on Sep. 30, 2010, which is incorporated by reference in its entirety.

### System Architecture

Systems, methods and framework allow processing of different types of collaboration related events and integration of event related data with the contents of media archives 101, 102, 103, and 104. Collaboration events are detected and processed via the collaboration event service 215. The event information is synchronously persisted within the UMF 106 representation of the media archive 101, 102, 103, 104. The UMF's 106 storage of the new collaboration event related data enables ease of programmatic interfacing via the UMF content application programming interface (API) 220. Meanwhile the content of the new additional stored collaborative event related data provides for ways in which the representation of the media resources is constructed and presented to the end user via the UMA 107 presentation services 201, 202.

Turning now to FIG. (Figure) 1, it illustrates the interactions of the three main system components of the unifying framework used to process media archives, namely the universal media converter (UMC) 105, the universal media format (UMF) 106, and the universal media aggregator (UMA) 107. As shown in FIG. 1, the UMC accepts input from various different media sources. The UMC 105 detects and interprets the contents of the various media sources 101, 102, 103, and 104. The resulting output from the UMC 105 interrogation, detection, and interpretation of the media sources 101, 102, 103, and 104 is a unifying media resource, namely the UMF 106.

The UMF 106 is a representation of the contents from a media source 101, 102, 103, and 104 and is also both flexible and extensible. The UMF is flexible in that selected contents from the original media source may be included or excluded in the resulting UMF 106 and selected content from the original media resource may be transformed to a different compatible format in the UMF. The UMF 106 is extensible in that additional content may be added to the original UMF and company proprietary extensions may be added in this manner. The flexibility of the UMF 106 permits the storing of other forms of data in addition to just media resource related content.

The functions of both the UMC 105 and the UMF 106 are encapsulated in the unifying system and framework UMA 107. The UMA 107 is the core architecture that supports all of the processing requests for UMC 105 media archive extractions, media archive conversions, UMF 106 generation, playback of UMF 106 recorded conferences, presentations, meetings, etc. The UMA 107 provides all of the other related services and functions to support the processing and playback of media archives. Examples of UMA 107 services range from search related services to reporting services and can be extended to other services that are also required in software architected solutions such as the UMA 107.

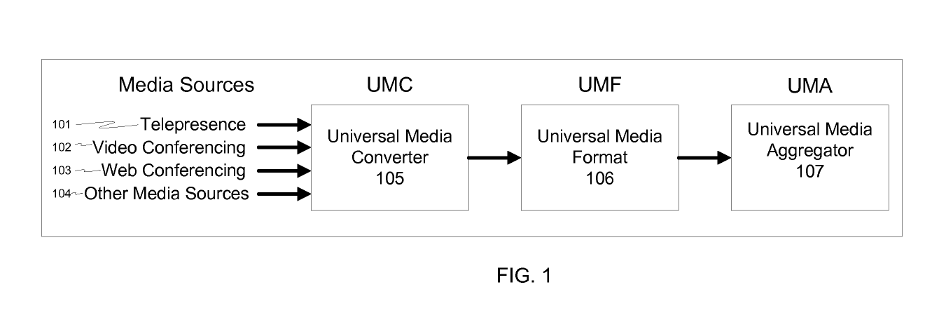

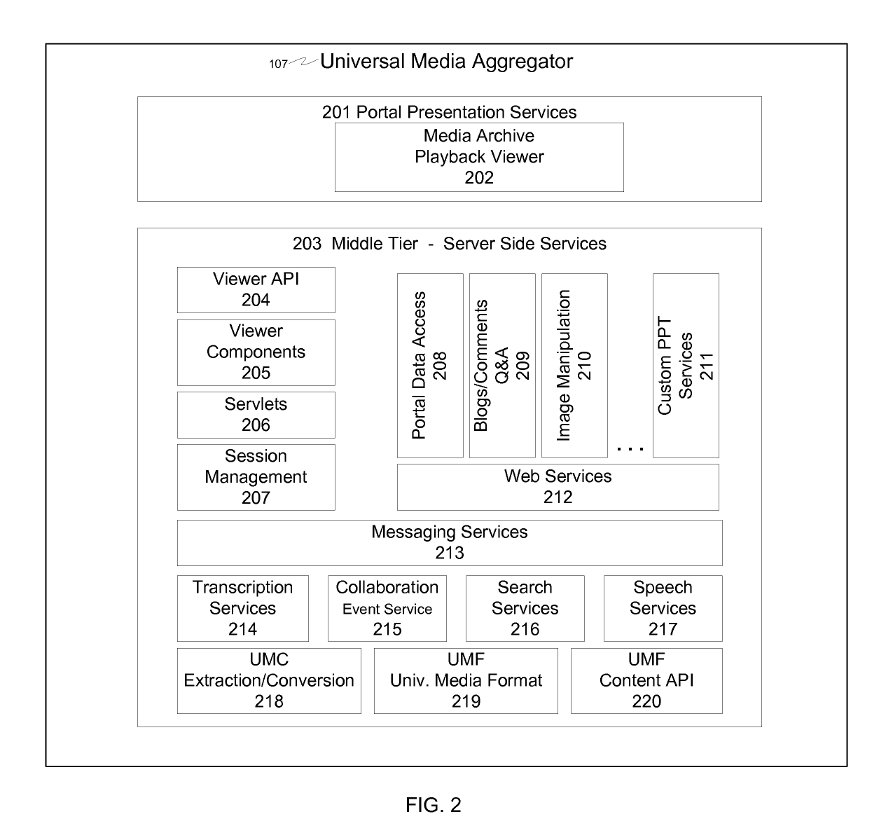

FIG. 2 depicts the major software components, that when combined together, form the unifying system and framework to process media archives, namely the UMA 107. For clarity, not all of the system components are included in the diagram and numerous other complementary and derivative services can be implemented in such software solutions. The UMC 105 is depicted as residing in the UMA 107 services framework as UMC extraction/conversion services 218.

The UMF 106 is depicted in the UMA 107 services framework as UMF universal media format 219. The collaboration event service 215 resides in the UMA 107 services framework. The collaboration event service 215 uses other services and features running within the UMA 107 framework.

The portal presentation services 201 of the UMA 107 services framework contains software and related methods and services to playback a recorded media archive, as shown in the media archive playback viewer 202. The media archive playback viewer 202 supports both the playback of UMF 106, 219 as well as the playback of other recorded media formats. The UMA 107 also consists of middle tier server side 203 software services. The viewer API 204 provides the presentation services 201 access to server side services 203. Viewer components 205 are used in the rendering of graphical user interfaces used by the software in the presentation services layer 201. Servlets 206 and related session management services 207 are also utilized by the presentation layer 201. The UMA framework 107 also provides access to external users via a web services 212 interface, A list of exemplary, but not totally inclusive, web services are depicted in the diagram as portal data access 208, blogs, comments, and Q&A 209, image manipulation 210, and custom MICROSOFT POWERPOINT (PPT) services 211. The UMA 107 contains a messaging services 213 layer that provides the infrastructure for inter-process communications and event notification messaging. Transcription services 214 provides the processing and services to provide the “written” transcripts for all of the spoken words that occur during a recorded presentation, conference, or collaborative meeting, etc. thus enabling search services 216 to provide the extremely unique capability to search down to the very utterance of a spoken word and/or phrase. Production services 215 manages various aspects of a video presentation and/or video conference. Speech services 217 detects speech, speech patterns, speech characteristics, etc. that occur during a video conference, web conference, or collaborative meeting, etc. Additional details of the UMC extraction/conversion service 218, UMF Universal Media Format 219, and the UMF Content API 220 are described in U.S. application Ser. No. 12/894,557 filed on Sep. 30, 2010, which is incorporated by reference in its entirety.

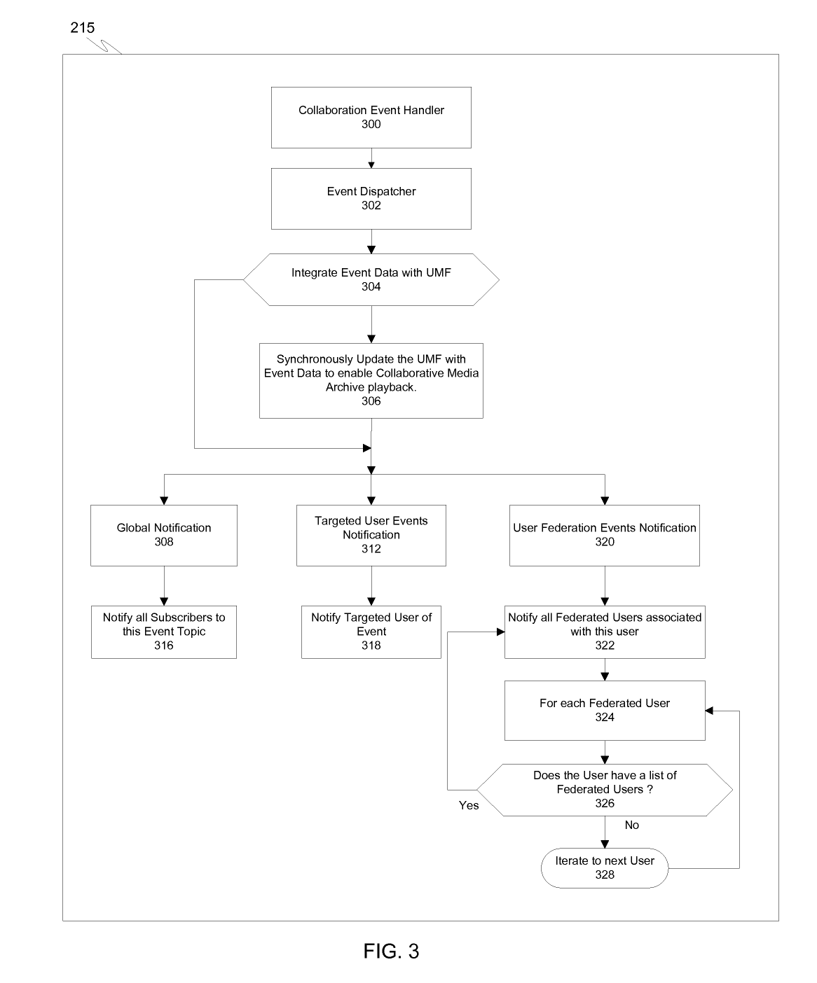

FIG. 3 illustrates an embodiment of a process for processing different types of events handled by the collaboration event service 215. The collaboration event handler in 300 receives various types of events. Some examples of the types of events are included in the following list: user notes, targeted user notes, contents from chat windows, recorded phone conversations, recorded teleconferences, output from a collaborative screen sharing session, the content from other UMF's 106, the output from other UMA 107 services (e.g., output from the speech services 216), audio clips, video clips, email or other documents, messages received from social network, for example, TWITTER, etc. It should be clear that the above mentioned list is to provide examples and that it should be clear that the collaboration event handler 300 of the collaboration event service 215 can be easily adapted to handle a wide range of other new and derivative types of events.

There are essentially the following different classifications for the various types of events received by the event handler 300, namely notification only types of events, targeted types of events, and user federation notification types of events. Each of the event types handled by the collaboration event handler 300 may optionally synchronously update the contents of a UMF 106. Synchronous update of UMF 106 causes UMF 106 to be updated with a time code associated with the point in time that the event originated. These synchronous properties are persisted in the UMF 106. The synchronous properties stored in the UMF 106 can be used during reporting, reviewing, or playback to correlate the event timings with the timings of the other related digital media resources. Some examples illustrate different classifications of collaboration events. The notification only event is the easiest to understand. Consider an example where users have “subscribed” through UMA 107 services to be notified when the content of media archives for specific topics of interest has been created or modified. In this example all of the subscribed users receive a notification only event when a media archive has been modified. The notification to the user may be set via user preferences and can be via any number of well known communication means, such as email, instant message, feeds from Really Simple Syndication MSS), TWITTER feed, short message service (SMS) text message, other social networking and collaboration sharing applications, for example, REDDIT or DIGG. In this example the notification contains the information about the updated media archive, a uniform resource locator (URL) to display the contents of the media archive, the criteria that matched the subscription request, etc.

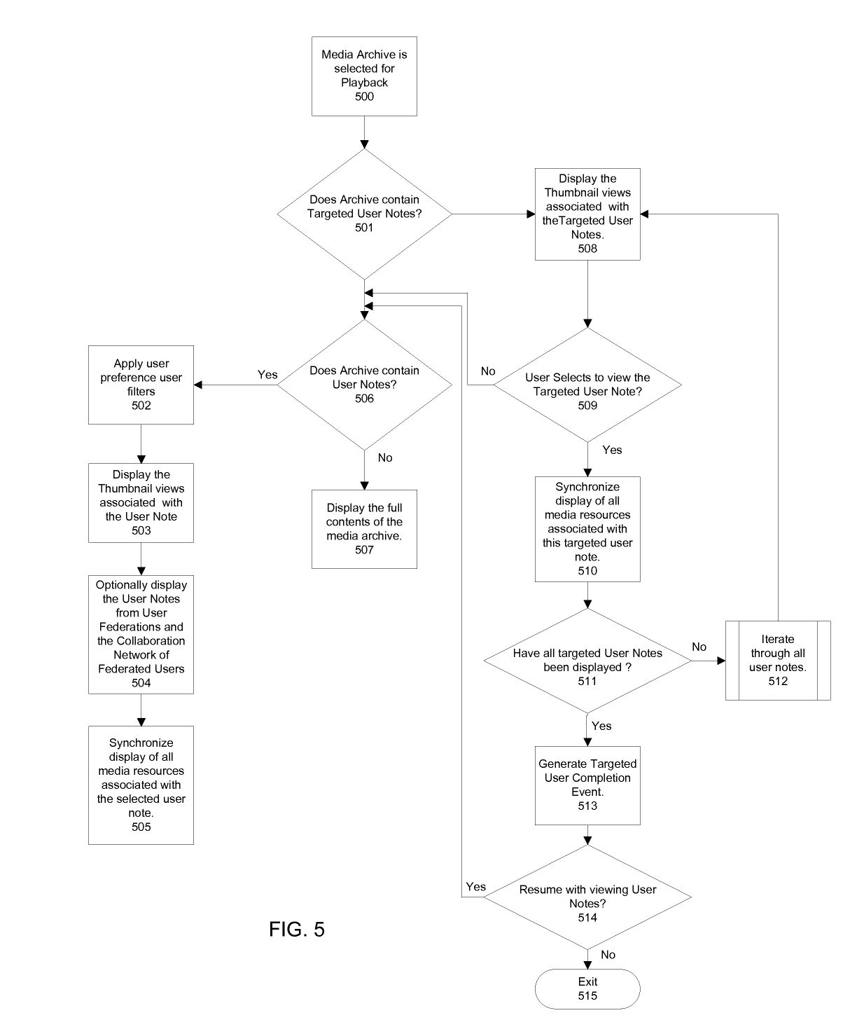

An example of a targeted type of collaboration event is when a sales manager may wish to not a sates associate, or a number of sates associates, about a particular subsection of a technical presentation that needs to be discussed with a client. In this example, the UMF 106 is synchronously updated with comments from the originator of the targeted collaboration event. Then a specific user, or set of specific users, receives a “targeted” notification via one of the above mentioned well known notification means. In this example, the notification contains information about the updated media archive, a URL to display the contents of the media archive, information about the originator of the targeted event, etc. There are also other types of targeted events where the UMF 106 is not updated with information. More detail on the processing of this type of event is covered in targeted user events notification 312 as well as in the section documenting FIG. 5 which describes the playback of a media archive with integrated types of user notes. For example, an email may contain the information for action disposition in the subject section, e.g., the subject may contain something like “Target Users” or there could be a special section in the bottom of the email reserved for the action disposition, e.g., just below the “signature” a special block may be filled in by the originator of the email to indicate the “action,” e.g., “Target User, User Receipt Required”, etc. An event definition is built by the system on behalf of the user's desired actions based on the sample event properties shown in table I further described herein.

An example of user federation event notification is the case when a single user adds supplemental descriptive notes to the contents of a UMF 106. In this case, other users who have also made additions to the same media archive/UMF 106 dynamically form a federation of users sharing interest in the contents of the same media archive. In this example, all of the users in the same user federation are notified along with the user federations dynamically formed by each of the other users in the federation. In this example, all of the federated users and all of the users that form the collaboration network 408 receive notifications.

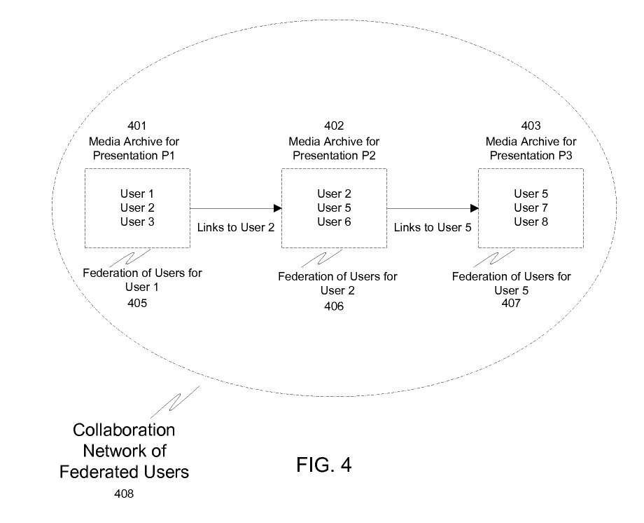

The notifications are sent via one of the above mentioned well known notification means. In this example, the notification contains information about the updated media archive, a URL to display the contents of the media archive, information about the originator of the user federated event type, etc. More detail on the processing of this type of event is covered in user federation events notification 320 as well as in the section documenting FIG. 4 which describes the concepts of the user federation 405, 406, 407 and the collaboration network of federated users 408.

Continuing now from step 300 and after the event is received from the collaboration event handler 300 the received event is then passed to the event dispatcher 302. The event dispatcher 302 then examines the contents of the event to determine if the event is a notification only event type or a data integration event type. A decision is then made whether or not to integrate the event data with the UMF 304. If the event is a type of data integration event, then the contents of the event is then forwarded to step 306 where the contents of the event are synchronously merged with the contents of the specified UMF 106. Note that the synchronous integration of the event data processing at step 306 enables the information from the collaboration event to be seamlessly and synchronously played back with all of the other contents in the media archive via the UMA 107 presentation services 201 and media archive playback viewer 202. Once the UMF update is completed in step 306, the process continues by passing the event to one of the notification handlers 308, 312, and 320 for processing.

If the decision at step 304 determines that the event type is notification only (i.e., no update of a UMF 106 is required), then the event is forwarded directly to one of the notification handlers 308, 312, and 320. Note that it should be clear that other types and variations of notification handlers can be easily adapted to the systems and methods disclosed and the examples and diagrams are not intended to be limiting factors. It should be clear to one with reasonable skills in the art to foresee that other event types and notifications can also be used in conjunction with, and/or in addition to, the disclosed description of event types and corresponding notification handlers.

The global notification handler 308 is configured to notify a list of subscribers when an event has occurred. For these types of events the user subscribes for topics, keywords of interest, etc. For example, a user may subscribe to an event to be notified when a presenter of interest is detected by the speech services 216 of the UMA, framework 107 to be actually participating, via voice communication, in a collaborative event. The speech services 216 is configured to detect the spoken voice from the participants in some form of collaborative event, such as a teleconference, web conference, presentation, town hall meeting, learning event, other form of collaborative event where voice input is used, etc. The spoken voice is then identified and then an event is generated which indicates that a specific speaker has been detected as participating in a collaboration event. In his example, the global notification handler 308 is configured to then notify all users that have subscribed to this event 316.

A feature of the types of event notifiers 312 and 320 is that no prior user subscription is required to receive event notifications. This is unlike the global notification 308 handler which requires a specific act by the user to subscribe to specific types of events. These other event notifiers 312 and 320 are collaborative and the user takes the advantages of these types of event notifications by virtue of simply participating in the UMA 107 framework and utilizing some of the available services. No overt action for user subscription is required to receive notifications for the newly disclosed collaboration events and associated event notification handlers 312, and 320.

One of the event handlers is the targeted user event notifier 312. There is a specific user, or a list of specific users, that are notified for this type of event. There can be two types of targeted notifications; dynamic and static notifications. Each of these notification types can be understood by examining a use case example. Consider the following example for the dynamic use case. Consider that a user is in the middle of viewing a 75 slide presentation on a topic and is then dynamically notified when another user (who happens to possess expert knowledge on the viewed topic has also started to view the same presentation. In this case the user can send a targeted collaboration event to the subject matter expert and request that they both collaborate and simultaneously view the same presentation. Since all of the resources in the UMF 106 representation of the presentation are synchronized, then both users can agree on which point in the presentation to start the collaborative review. The subject matter expert sends a targeted user event back to the request back to the requester with the response to accept or deny the request for the simultaneous collaborative review of the presentation. The notification for these targeted user events are handled by the collaboration event service 215 and specifically handled in the targeted user event notification handler 312.

Another example of the dynamic targeted user event notifier 312 is the case of a sates manager that wants to simultaneously collaboratively review the contents of a media archive with a select number of sales associates that are spread across many regions and time zones. In this case the sales manager initiates the request to collaboratively review the contents of a recorded sales event. The request is targeted to a select number of sales associates. The targeted user events notification handler 312 then dynamically sends notifications to each user in the list of targeted users. The targeted users send responses back to the requestor, in this case the sales manager, either accepting or denying the request to collaboratively review the contents of a recorded sales event. The targeted user events notification handler 312 then sends the response notifications back to the targeted user, in this case the sales manager.

All collaborators will simultaneously review the recorded sales even and utilize other collaborative tools such as the capability to synchronously add user notes to the original recorded presentation. Consider the following example for the case of static targeted notifications. For this example consider a two hour presentation on all legal aspects of open source software. Further consider that there are aspects of the presentation that pertain specifically to intellectual property law attorneys and there are other sections of the presentation that pertain specifically to software developers. The targeted user notifications can be used to optimize the time spent reviewing the example presentation. Instead of sifting through the entire two hour presentation for relevant material, the senior attorney may send targeted user notes to a list of targeted users on his staff.

A media archive can be played back starting with a particular position of the media archive. A position of the media archive corresponds to synchronized positions of various media resources of the media archive. For example based on correlated elements of sequences of various media resources of media archive, positions of the media resources can be correlated. The correlated positions of the media resources can be presented to the user as positions of the media archive. If the user requests playback of the media resource starting from a position of the media archive, the UMA 107 identifies the corresponding positions of each media resource and performs simultaneous playback of the media resources from their identified positions.

In an embodiment, a playback of the media archive or a portion of the media archive is targeted to a specific set of users, a particular user, or a category of users. A request for playback can specify a predefined category of users for whom the playback is requested. A user requesting access to the playback can be denied his request if the user does not belong to the appropriate category. For example, a playback can be requested for executives of a company. Employees of the company that are not executives will be denied their request to join a collaboration session for the playback. On the other hand, users belonging to the specific category associated with the playback are allowed to join the collaboration session for the playback. The playback session can be targeted to an enumerated set of users. A user requesting to join the collaboration session is allowed if the user belongs to the enumerated sa of users, or else the user denied request.

In an embodiment, portions of the media archive can be redacted from presentation to all users, a selected set of users, or a specific category of users. For example, a system administrator can specify that a portion of the media archive between a start position and an end position is redacted. The start position and the end position of the media archive are associated with corresponding positions in the media resources based on synchronization of the media resources. If the portion of the media archive is redacted for a specific set of users, any user belonging to the set is denied access to the information in the redacted portion. For example, a user may request presentation of the entire media archive. The user is presented with the information in the media archive except for the redacted portion. If the user makes a request for a specific portion that falls within the start and end positions of the redacted portion of the media archive, the request is denied.

The redacted portion can be associated with a category of users for whom the portion is redacted. The categories of users requesting information belonging to the redacted portion are compared with the category associated with the redacted portion. If the categories match, the user is either denied access to the information. Alternatively, the user can be presented with other portions of the media archive while withholding the redacted portion. In an embodiment, user notes associated with positions within the redacted portion are also withheld for users not allowed to access the redacted portion. The redaction of media archive beneficially allows a system administrator to prevent playback of certain portions of a video and associated synchronous media resources, e.g., a slide presentation or a collaboration session from being viewed by certain sections of viewing public.

Not all media resources of the media archive need to synchronize corresponding to each position of the media archive. For example, a certain portion of the media archive may be augmented with an additional media resource compared to other portions of the media archive. Accordingly the portion of the media archive that is augmented with additional media resource may have more media resources compared to other portions of the media archive. As another example, the media archive may comprise an audio resource and a text resource obtained by transcribing the audio resource. However, not every portion of the audio resource my be transcribed. Therefore, the text resource may be synchronized with the audio resource for certain portions of the media archive and can be missing from other portions of the media archive.

The user can specify a start position and an end position of the media archive. The UMA 107 starts playback the media resources at the start position and stops the playback at the end position. There may be multiple user notes associated with a media archive. If the user requests a playback from a start position, only the user notes associated media resources at positions that occur after the start position are presented to the user. If the user requests playback of a portion of the media archive between a start position and an end position, the UMA 107 presents only the user notes that corresponds to positions of media resources between the start and end positions. In other words, during a playback of a portion of the media archive, the user notes outside the selected portion of media archive are skipped.

A user note added to the media archive is treated the same was any other media resource of the media archive. Accordingly, a user note may be added to another user note, thereby allowing arbitrary nesting of user notes. For example, a user note in an audio format may be added to the media archive. The audio user note can be further augmented by a text user note that corresponds to the transcription of the audio user note. Furthermore, the text user note corresponding to the transcription of the audio can be augmented with other user comments.

In an embodiment, the user note can itself be a media archive. For example, a subsequent short meeting or a short collaboration session may be held to discuss a particular aspect of a presentation or a particular slide associated with a media archive. The short meeting may be stored as a media archive. The media archive corresponding to the short meeting can be added as a user note and associated with a position of the original media archive corresponding to the slide being discussed or any other portion being discussed.

A user note may be associated with a specific position of the media archive or a portion of the media archive. For example, the user note may describe a set of slides in a presentation and may summarize a significant portion of a presentation. The note may be presented while displaying/presenting any particular position of the media archive within the associated portion. For example, if the user is viewing the entire presentation of the media archive, the user note can be presented when the first position of the associated portion is encountered. If the user is viewing a subset of the media archive, the user note may be presented the first time any position associated with the user note is presented.

A user requesting playback of a portion of the media archive may filter the user notes during the playback by specifying criteria associated with the user notes. For example, the criteria for filtering the user notes may specify playback of user notes provided by a particular user. Alternatively, the user notes presented may be filtered by the content of the user note, for example, only user notes including certain search terms may be presented. Other criteria for filtering user notes include specifying a timestamp such that only user notes added after the time stamp may be presented. A start and an end time stamp can be specified to filter user notes added within the start and end time stamp. A geographical location associated with the user adding the user note can be specified as criteria for filtering user notes. Only the user notes associated with a specific media resource or all media resource with a specific media format may be filtered. For example, the user may filter all user notes associated with audio resources. Other criteria filter user notes provided in a particular media format, for example, a user may want to filter only user notes in text format or only user notes in audio format. The various criteria disclosed herein can be combined with each other.

In an embodiment a portion of the media archive between a start position and an end position can be extracted and stored. The extracted media archive can be transmitted to users interested in specifically the extracted portion of the media archive. The ability to synchronize the media resources allows the UMA 107 to determine the corresponding start and end positions of each media resource. Alternatively the user can specify multiple non-overlapping ranges of start and end positions of the media archive that should be extracted and stored in a single destination media archive.

During the process of extraction of a portion of the media archive, the user notes associated with the portions of media resources selected for extraction are also extracted and stored. Criteria may be provided to the UMA 107 to select a subset of user notes to be extracted. These criteria can be as described above for playback, for example, user notes added by a particular user, user notes added after a time stamp, user notes added during a particular time window, user notes added by users from a geographical region, user notes including particular search terms, and the like.

Allowing extraction of a particular portion or portions of a media archive allows the extracted portion to be provided to a set of users that are likely to be interested in the extracted portion and not necessarily interested in the remaining portions of the media archive. The extra ted media archive can be transmitted to the target users, for example, as email attachments, or downloaded via the internet. Alternatively a message comprising the pointers to one or more start and end positions of the media archive can be sent to a user as part of a script. The script extracts the relevant portions of the media archive runtime given the location of the media archive.

In this case, the senior attorney is targeting the specific sections of the presentation that his staff needs to review, instead of having each of his staff members spend two hours viewing the entire presentation. Likewise, the manager of the software engineering department ent may send targeted user notes to his staff members for the sections relating to software developers use of open source software. In this way the software developers only need to review the relevant required content of the presentation instead of viewing the entire contents of the two hour presentation.

Note that the examples in this section are considered static, in that the originator does not require a real time response to the generated targeted user event. In both of the examples in this section, the target user event notification handler 312 sends the event information to the specified user. Note that the event in infrastructure solution is also capable of sending events back to the originator when the targeted users have completed the review of the original targeted user event material and therefore provide a compliance tracking mechanism.

In an embodiment, various users can subscribe to a particular event associated with a playback of a media archive. The users are notified upon occurrence of the corresponding event. For example, a user can subscribe to the event correspond to a particular user joining the playback session. A user can also subscribe to a search term occurring during the playback. For example, a user may know the title of a particular slide in a presentation and may provide the slide title as a search term. During the playback, when the slide title is encountered, the user is notified. The search terms may be identified in text resources of the media archive by text matching. The search terms can also be matched against image or video resources by performing optical character recognition of the images/videos. Similarly, the search terms can be matched against an audio resource if transcription text corresponding to the audio is available.

The UMA 107 can determine before the search term is going to be played back and can inform the user in advance (say a few minutes before the slide is played back). This provides advanced notice to the user that the requested slide is going to be played back. The search term can be matched against text media resources as well as media resources that can be converted to text representation for example, via transcription of audio or OCR of images. The UMA 107 can prefetch images being presented during the playback and perform OCR on the images to determine in advance whether a search term is going to be displayed.

In an embodiment, during playback of a media archive that comprises an audio resource, the user can specify recognition of voice of a particular user as an event to which the user subscribes. The UMA 107 equipped with voice recognition capability can identify the presence of the particular user via voice recognition and notify the subscribers.

Although the term “user notes” has been used as a way to describe the functionality, it should be noted that the user can add different types of customized notes to assist them in their learning endeavor, for example, audio clips, video clips, links to other related presentations, etc. When these user notes are added to a media archive, it should be noted, that they also become a “synchronized resource” and as such can also be searched down to the spoken/typed word. Two resources are synchronized if they are associated with information that allows correlating portions of the resources with temporal formation. And during the view of a media archive, when the individual search result is selected the user navigates to the exact synchronized view in the presentation viewing all of the associated synchronized resources; namely PPT, audio, video, scrolling transcript, chat window, thumbnails, user notes, phone/audio clips, TWITTER events, etc.)

In an embodiment, a user note comprises one or more media resources. A media resources belonging to the user note is synchronized with a media resource of the media archive. Media resources within the user note are also synchronized with respect to each other. As a result any media resource in the user note can be synchronized with respect to any media resource in the media archive. For example, the user note may comprise a media resource in text format and a media resource in audio format. This may happen if a user is adding notes to a presentation by providing textual comments as well as audio comments for a set of slides in the presentation. The text media resource of the user note is synchronized with the audio media resource of the user note. Further if any media resource of the user note is synchronized with a media resource of the media archive, the user note can be presented along with the media archive. For example, the text comments of the user note can be presented when the media resources of the media archive are presented. The synchronization between the media resources of the user notes allows the universal media aggregator 107 to present the user notes in their proper context while presenting the media archive. For example, a portion of the user note relevant to a particular slide is present when the slide is presented. Similarly, a portion of audio in the user note associated with a particular slide can be presented when the slide is displayed to a user.

The media archive may already have an audio resource apart from the audio resource added as part of the user note. For example, a presentation by a user for a web meeting may include an audio. If the user note adds a second audio resource, the audio resource of the media archive can be substituted by the audio resource of the user note during playback to allow the user to listen to only one audio at a time. The person playing back the media archive can listen to the original audio or to audio corresponding to comments by the users added as user notes. In an embodiment, a user can request playback of only selected media resources of the media archive. The user can also request playback of selected media resources of the media archive along with selected media, resources of one or more user notes. For example, there may be a user notes with audio resources from different users each commenting on a different slide or sets of slides of the presentation. Synchronization across media resources of the user notes, synchronization across media resources of the media archive and synchronization between media resources of the user notes and the media resources of the media archives allows the universal media aggregator to determine the portions of each media resource that need to be played together so as to create a coherent presentation for playback.

The user note is typically associated with a second event corresponding to the user adding information to a stored media archive. The media archive itself is recorded as part of a first event, for example, a presentation that occurs during a time interval. The event corresponding to addition of the user note typically occurs during a time interval that occurs after the time interval of the first event. A user input may indicate a portion of the media archive with which the user note is associated. In an embodiment, user notes may be input by speaking into the microphone enabled PC and then the notes will be instantly and dynamically auto-transcripted into searchable user notes text via use of the UMA 107 speech services 216. Other useful “grammars” can be used to navigate to, or insert comments into, synchronized points in presentations, user notes, transcriptions, chat windows, or other presentation resources.

Security levels stored in UMF 106 are described in the U.S. application Ser. No. 12/894,557 filed on Sep. 30, 2010, which is incorporated by reference in its entirety. The collaborative aspects disclosed herein can be used by personnel of appropriate security levels, to synchronously insert advertising displays or other promotional offerings, to timed intervals throughout a presentation. Likewise, it should be clear to those skilled in the art, that the collaborative event system disclosed herein can be used by the end user to “target” removal of these time interval based advertising displays, for example, via an agreed to fee.

An advertisement can comprise multiple media resources. In an embodiment, the media resources of the advertisement are matched with the media resources of the media archive. For example, the media archive may comprise an audio resource and a text resource among other media resources. An advertisement may be provided that a text resource and an audio resource that corresponds with audio associated with the text of the text resource. The advertisement may be inserted in the media archive at a specific position in the media archive. The ability to synchronize the various media resources of the media archive allows the universal media aggregator 107 to determine positions in each media resource where a corresponding media resource of the advertisement is inserted. For example, a particular offset (or position) in the audio resource of the media archive is identified for inserting the audio of the advertisement. Synchronization between the audio resource and the text resource of the media archive is used to determine the corresponding position in the text resource of the media archive for inserting the text resource of the advertisement. The position in the audio resource where the audio of the advertisement is inserted may be provided by the user or automatically determined. Accordingly, given a position of a particular media resource of the media archive for inserting the advertisement, the positions of the other media resources of the media archive are determined based on the synchronization between the different media resources. The media resources of the advertisement are matched with the corresponding media resources of the media archive and inserted in the appropriate positions identified. In an embodiment, inserting of the secondary media archive does not require physical insertion of the media resources of the secondary media archive into the media resources of the media archive but storing pointers to the media resources of the secondary media archive. Thus, minimal additional storage is required for the media archive being augmented. In an embodiment, the secondary media archive corresponds to a portion of a larger media archive which is synchronized. Such portion can be specified using a position and size of the portion or a start and an end position. The portion of the media archive comprises synchronized portions of the various media resources of the larger media archive. For example, a portion of a second presentation which is relevant to a first presentation can be inserted in the first presentation at an appropriate place in the presentation.

If the media archive comprises additional media resources that do not match the advertisement, these media resources are padded with filler content (that may not any new information to the media archive) so as to maintain synchronization between various portions of the media archive during playback. For example, if a video resource of the media archive does not match any media resource of the ad, the video is padded with filler content, for example, a still image during the period the advertisement is presented. As another example, a slide presentation in which the media resource representing the slides does not have a corresponding media resource in the ad, a slide with generic information related to the presentation (e.g., a title and a brief description of the presentation) or information describing the ad can be shown while the advertisement is being presented.

The advertisement inserted in the media archive can also be removed based on information describing the positions of the media resources of the media archive where the media resources of the advertisement are inserted and the lengths of the resources of the media archive. This position information of the ad is stored using the universal media format 106.

The process of inserting advertisements in a media archive can be generalized to inserting a secondary media archive in a primary media archive. For example the primary media archive may comprise a presentation on a particular topic. It is possible to insert a secondary presentation on a subtopic covered in the original presentation. This allows enrichment of the original media archive with information determined to be relevant to the topic of the media archive.

Similarly a portion of the media archive can be removed for various reasons. For example, a portion of a presentation may be removed because it comprises sensitive material or material not relevant to the topic of the presentation. To remove a portion of the media archive, a position of a media resource can be provided by a user. For example, a user indicates that a set of slides beginning from a particular slide onwards need to be removed. The positions associated with the portion of the media resource to be removed are determined, for example, a position and size of the portion to be removed, or a start and end position of the portion to be removed. Synchronization between various media resource is used to determine the corresponding positions of the other synchronized media resource that should be removed. Synchronized portions of the various media resources are removed so that the remaining portions of the media resources of the media archive form a consistent media archive for presentation during a playback.

Another embodiment allows event notification in the form of user federation event notification 320. First the concept of user federations and the concept of the collaboration network of federated users are described. A user federation refers to a set of users that are related to each other due to their collaboration on one or more events. Referring to FIG. 4, there is a diagram depicting the users of the UMA 107 framework services, user federations 405, 406, and 407, the inter and intra relationships of the federated users, and the dynamically generated collaboration network of federated users 408. As an example, consider three distinct media archive presentations 401, 402, and 403 where a set of users have added user notes to the content of each of the presentations. Note that users 1, 2 and 3 have made user note contributions to presentation 1 401 and thus collaboratively improving the content of the original presentation. The users that make user no contributions to a presentation are automatically and dynamically included in a user federation for the specific presentation. As shown in the diagram users 1, 2, and 3 are members of the user federation for presentation P1 401, users 2, 5, and 6 are members of the user federation for presentation P2 402, and users 5, 7, and 8 are members of the user federation for presentation P3 403. In an embodiment, when a user note is added to the media archive, all users that subscribed to the media archive are notified. A user may subscribe to the media archive by providing information allowing the system to notify the user, for example, an email address of the user at which notification messages can be sent. In another embodiment, the list of users notified in response to a user note is all the users that are determined to have viewed the presentation. Some embodiments determine lists of users by combining various lists, for example, users that added user notes to the media archive as well as users that explicitly subscribed for notifications.

In an embodiment, the users notified are users that have interacted with the specific portion of the media archive to which the user note is added. For example, a long presentation may comprise several portions during which different speakers may have presented material. Some portions of the presentation may be suitable for highly technical people, whereas other portions may be suitable for people interested in business aspects of a product, and yet another portion of the presentation may be suitable for executives or management of the company. These portions are identified for the media archive, for example, based on user input. The synchronization of the media archive allows identifying portions of the media resources that are associated with each other and need to be played back together. A user note added to a specific portion of the media archive results is notification messages being sent to users associated with the specific portion, for example, users that previously added user notes to this portion. This way, users not interested in the specific portion to which user note is added are not notified.

In an embodiment, the access rights of users of the media archive are limited to specific portions. For example, a portion of the presentation may include information shared across executives of the company and people who are not executives are not provided access to this portion. The ability to synchronize the media resources allows specifying different levels of access to different portions of the media archive, for example, by maintaining different access lists for different portions. In these embodiments, the list of users notified when a user note is added to a portion of the media archive is further filtered by the level of access required for the portion. For example, a user may subscribe for notifications related to a specific portion of the media archive but may not be sent notification if the user doesn't have the required access.

Now further consider the case where user 1 makes several user note additions to presentation P1 401 and then commits the changes to be persisted via the UMA 107 framework services and for the specific UMF 106 for media archive presentation P1 401. Upon saving of the user note changes, a user federation event is generated that is eventually handled by the user federation events notification handler 320. Initially, when user notes are saved, each user in the federation is notified via 320. In this example user 2 and user 4 will receive notifications indicating that user 1 has added user notes to presentation 1 401. In addition to the initial step of notifying all of the federated users associated with presentation P1 401, each of the users in the user federation are also examined to determine if those users belong to any other user federations. In this example, user 2 is also member of another user federation 406 and each of the members of this user federation is also notified (in this case user 5 and user 6). Then, likewise, each of the federated users for user 2 is also examined to determine if those users belong to any other user federations. In this example, you can see that user 5 is also a member of another user federation 407 and then all of the federated users for user 5 407 are also notified. Note that the collection of interconnected user federations 405, 406, and 407 forms a dynamic collaboration network of federated users 408. The notification process of notifying each of the federated users and any members related to the federated users continues iteratively through the entire collaboration network of federated users 408.

Embodiments improve user collaborations via the dynamically formed set of inter related user federations and the resulting collective collaboration network of federated users. The processing steps for user federation event notifications 320 are described next. In step 322 notifications are made for all federated users that are associated with the user that originated the collaboration event.

Step 324 comprises an iterative process for each federated user to checks if the federated user belongs to another user federation 326. For example user 2 in federation of users for user 1 405 also belongs to another user federation 406. If the federated user belongs to another user federation then processing continues again in a nested manner at step 322 and to notify all of the federated users for this user federation 322 and proceeds in the same nested manner with steps 324 and step 326 until the entire collaboration network of federated users 408 has been notified. When there is no inter-related user to other user federations relationships, then processing continues at step 328 to iterate to the next federated user and the process unwinds in this manner from the various nesting levels that may exist in the collaboration network of federated users 408.

In an embodiment other types of information is used for creating a relationship between two user federations 326. For example, topics based on information available in the collaboration session between user federations can be used to identify topics of interests to members of the user federation. The topics of interest to a user federation are based on significant topics discussed in the collaboration. Topics are weighted based on the number of occurrences of the terms related to topics in the collaboration sessions and related media archives. Significant topics related to the collaboration session are identified based on the weights. For example, an occasional reference to a term may not rise to the level of a topic for the user federation. On the other hand repeated mention of certain terms may be considered significant to the collaboration sessions. The overlap of topics associated with user federations may be used to determine if a relationship is defined between two user federations. A relationship may not be added between user federations based on very little overlap of topics of interest even if there is slight overlap of members.

Another factor considered in determining relationships between user federations is the number of members overlapping between the user federations. At least a threshold number of member overlap may be required to consider two user federations related. This avoids creation of relationships between user federations due to a few members having very diverse interests. For example, a particular user may have two diverse interests, electronics and anthropology.

The analysis of user federations before creating a relationship avoids creating a relationship between user federations based on electronics collaboration sessions with user federations based on anthropology sessions due to a single user overlapping between the two collaboration sessions. In an embodiment, the frequency of user overlaps is identified between user federations before creating a relationship between the users. For example an occasional user overlap created by an isolated user peeking into a different collaboration session is not considered a significant overlap to create a relationship between the two user federations. In an embodiment, an inferred relationship may be created between user federations based on topic analysis even though there is no overlap of users. Thus a relationship may be created between two user federations with very large topic overlap even though there is no user overlap at present.

The system generated relationships between user federations are tagged separately. Users from one user federation will be informed of future presentations related to a related user federation. Historical data may be analyzed to see if a real user overlap occurs between two user federations subsequent to creation if a system generated relationship exists between the user federations. If a system generated user relationship leads to no actual membership overlap for a significant period of time, the system generated relationship may be broken.

In an embodiment, hierarchical groups of user federations are created by combining user federations. Weights may be assigned to relationships between user federations. A high weight of a relationship indicates a close relationship between two user federations compared to a low weight relationship. Groups of user federations based on high weights are combined into larger groups. The combined groups may be further combined into larger based on lesser weight relationships. This creates a hierarchy of user federations where the user federations that are high in the hierarchy include larger groups comprised of groups lower in the hierarchy. Groups larger in the hierarchy may be based on users that are loosely connected whereas user federations lower in the hierarchy are based on users that are tightly connected. For example, a user federation high in the hierarchy may include people interested in software development whereas user federations tower in the hierarchy under this user federation may include user federation of people interested in databases, or user federation of people interested in network infrastructure or user federation of people interested in social networks. If a new collaboration session is started, a user may decide the level of user federation that needs to be informed of the collaboration session. For example, in the above example, even though a collaboration session may be related to social networks, the presentation may be a very high-level presentation catering to a broader audience. In this case a user federation much higher in the hierarchy may be identified for informing the users of the new user collaboration session. On the other hand, if the new collaboration session is on social network but involves technical details that may not be of interest to the general audience a user federation much lower in the hierarchy is selected and informed of the new presentation.

Although the description up to this point has focused on collaboration events that are essentially generated within the confines of the UMA 107 framework, it should be clear that the disclosed systems and methods can be adaptable to receive events from various forms of external sources. For example, TWITTER feeds, RSS feeds and other forms of social networking and Web 2.0 collaboration toots can be sources for external events that can also be processed by the disclosed systems. Other well known forms of software adapters can also be developed to connect external events with the UMA framework 107 and the collaboration event services 215. For example, an adapter may be developed to search for content on YOUTUBE, GOOGLE, technology talks delivered on technology forums, any form of searchable media, or even new books available on certain topics that are newly available from online book-sellers. These types of adapters provide the bridge between external events and the disclosed collaboration event handling service 215.

FIG. 5 is a flowchart documenting the flow for the playback of media archives containing different types of user notes. The functional description supports the following use case example. When the user selects to playback a media archive presentation, the user notes are displayed and another window is also displayed with a scrollable set of thumbnail views that are synchronized with both the specific user note and the synchronized view in the PPT presentation.

The same is true for targeted user notes. The user then has the opportunity to scan through the series of scrollable user notes and associated thumbnails for a synchronized selection whereby the thumbnail view is providing a visual assist to the user (e.g., this helps the individuals that learn best by visual means). When the specific thumbnail is selected, the user navigates directly to the view of all of the other synchronized media resources that are contained in the media archive (namely; PPT slides, audio, video, scrolling transcript, chat window, phone/audio clips, TWITTER events, etc.) If the user has viewed a series of targeted user notes, and if the originator of the targeted user notes has requested a confirmation response, then a targeted user note completion event is sent back to the originator.

Continuing with the explanation for FIG. 5, the playback of a media archive is initiated by the user selection at step 500. Then the software module that is responsible for controlling the user vim determines if the media archive contains targeted user notes. If the selected media archive does contain one or more targeted user notes, then the processing continues at step 508. At step 508 the presentation layer renders both the targeted user notes as well as a thumbnail view of the presentation slide that is synchronously associated with each of the targeted user notes. Then processing continues at step 510 to determine if the user chooses to select one of the targeted user notes. If the user affirmatively selects one of the user notes, then the presentation layer code renders the synchronized display of all of the media resources that are associated with the targeted user note (e.g., the slide, audio, video, scrolling transcript, etc.). Then at step 511 a check is made to determine if all of the targeted user notes ha-e been displayed. If the user has not viewed, or has selected for view, all of the targeted user notes, then the controller code iterates through the remaining targeted user notes 512 and then processing resumes back at 508 to display the remaining targeted user notes and associated thumbnails. When all of the user notes have been displayed, as determined by the check made at 511, then an event is optionally generated and sent back to the originator indicating that the user has completed the views of all of the targeted user notes that were embedded in the UMF 106 representation of the media archive presentation. Once all of the targeted user notes have been viewed, the user has the option at step 514 to end the view of the presentation 515 or to resume by viewing the rest of the presentation at step 506. If at step 509 the user selects to bypass the view of the targeted user notes then processing continues for viewing the rest of the media archive presentation at step 506.

Also during the playback of a media archive presentation, a check is made 506 to determine if there are any user notes that are embedded within the UMF 106 representation of the media archive presentation. If the UMF 106 representation of the media archive does not contain any user notes, then the code controlling the view of the presentation displays the entire contents of the media archive 507. If the UMF 106 representation of the media archive does contain user notes, then processing continues at step 502 to determine if any user preferences have been defined to filter-in or filter-out any users from the display of user notes. The user preference filter options are then applied in step 502. Once the filtering has been applied, then the presentation layer code renders the display of both the user notes and as well as a thumbnail view of the presentation slide that is synchronously associated with each of the user notes 503. At step 504 the presentation layer code, optionally based on user preference settings, also renders the display of all of the user notes from the collaboration network of federated users 408. Then processing resumes by handling the synchronous display of all the media resources that are associated with the selected user note 505.

Embodiments allow various ways to display collaborative information. For example, by virtue of the inter-connected relationships that are dynamically formed in the collaboration network of federated users, then a multi-dimensional view can be presented to the user, where each dimensional view is another individual users “take” of the presentation as represented in their user notes collaboration. This allows playback of media archives to display multiple, parallel, distinct, user note resources that are presented simultaneously to the user. These additional parallel dimensional “takes” could be represented to the user as a unique user interface as an n-sided polygon. For example, if there are two user notes then maybe a simple 2 dimensional split screen will suffice, when there are three “takes”/dimensions then a triangle is rendered (where each side of the triangle represents a different users collaboration via user notes for the media archive presentation), and when 8 then an octagon, etc. In one embodiment, the process is configured to represent the view as a rotatable 3 dimensional polygon, or other means to represent this unique collaboration of synchronized multi-user inputs, comments, questions, or corrections etc. to a single presentation. Note: the multiple such views of the media archive presentation can be simultaneously rendered and displayed to the user. Note also that a simple hierarchical tree sort of user interface could also be used to represent user notes that are contained in the collaboration network of federated users 408.

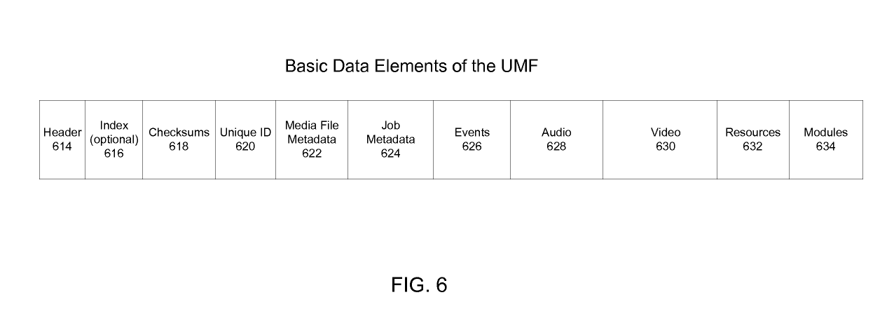

FIG. 6 is a storage diagram showing storage of the user notes in the UMF 106. The UMF 106 is both flexible and extensible and both collaboration events and user notes may be represented in the UMF 106. An example embodiment of the UMF 106 is also described in the U.S. application Ser. No. 12/894,557 filed on Sep. 30, 2010, which is incorporated by reference in its entirety. The UMF header 614 contains the unique information to identify the data block as a UMF and contains other useful identifying information such as version numbers, etc. The index 616 is optional and is primarily used to optimize searches. The checksum 618 is used to provide data integrity for the UMF. The unique ID 620 is way to identify each individual UMF. Media archive metadata is contained in section 622 and job metadata 624 is usually related to the production aspects of the media archive. Event 626 is used to represent actions that occur during a media archive presentation, e.g., the flip of a slide to the next slide. Audio is represented in data block 628 and video represented in data block 630. The user notes and targeted user notes are included in the resources 632 section of the UMF. Embedded programming modules may optionally be included in section 634 of the UMF.

The table I shown below lists examples of event properties that can be encapsulated and persisted in the UMF Event Block 626 of UMF 106 shown in FIG. 6. It is a non-inclusive list of event properties and other variations (both simple and complex) and extensions to this list of event properties is possible. The event properties include metadata associated with events as well as data associated with the events. This custom event data and event metadata from the table I can be represented in a variety of well known formats including, but not limited to XML, JSON (JavaScript Object Notation), etc. The UMF persisted event information 626 can be used for reporting/review and may be retrieved in a variety of formats requested by a user as described in U.S. application Ser. No. 12/894,557 filed on Sep. 30, 2010, which is incorporated by reference in its entirety. The information persisted in the event information 626 includes metadata related to the event, for example, information shown in table I along with the content or data of the event.

TABLE I

| Property Name | Description |
|---|---|
| Event Type | For example: notification only types of events, |
| | targeted types of events, and user federation |
| | notification types of events. |
| Event Sub Type | Used to further distinguish the more general |
| | event type classifications. |
| Notification methods | e.g., dynamic real time notification or static via |
| | email. |
| Actions | Required actions, e.g., an event received |
| | confirmation sent back to the originator. |
| Sender Identifier (ID) | Identifies the originator sending the event. |
| Target IDs | Optional list of targeted id's |
| Instance ID | Unique identifier for this instance of the event. |
| Correlation ID | A unique ID used to correlate and/or track |
| | originating events with any subsequent event |
| | notification. |
| Sequence ID | Event information may span multiple events. |
| | This optional property identifies the Sequence |
| | number for this type of event (e.g., 1 of N) and |
| | indicates the order in which the events should |
| | be processed. |
| Context ID | Optional, e.g., may indicate a UMF Unique ID |
| Context Type | Used to indicate the context for the given |
| | event, e.g., indicates a Presentation has been |
| | added, or a User Note has been added, or a |
| | targeted user note, etc. |
| Collaboration | Indicates the type of collaboration event, a |
| Event Type ID | non-inclusive list of examples: teleconference, |
| | web conference, presentation, user notes, |
| | instant messaging chat, twitter feed, recorded |
| | phone conversations, email, video clip, screen |
| | sharing session, etc. |
| Context Properties | Timestamp of the originating event, or |
| (Synchronization, | geographic location of the originating event. |
| geographic, etc.) | |
| Tag | Topic Keywords used to define the event. |
| Collaboration Specific | e.g., identifying properties such as the Speaker |
| Event properties | ID used in voice detection related events. |
| Event Payload | Event data. |

The event data and metadata stored in UMP 106 is used by various embodiments. For example, the target IDs property (shown in table I) can be used to store lists of targeted users that can be recipients of targeted user notes. Event property storing context properties (shown in table I) can be used for generating reports classifying actions based on geographical information, demographic information, and the like. For example, reports showing geographical or demographic distribution related to participations in a collection of collaboration session can be generated.

The contents of external events can also be stored in the UMF. For example, TWITTER and text messages can be represented in the XML encoding for SMS messages format and then encapsulated within the UMF. In summary, the disclosed methods and systems provide a significant improvement, to the state of the art handling of collaboration events. The disclosed collaboration event handling service handles various types of events via event notifiers. The disclosed collaboration event handler 300 allows various forms of targeted and non-targeted types of events. The disclosed collaboration event processing allows user federations 405, 406, and 407 that collectively reside within a collaboration network of federated users 408. The collaboration event processing supports external events such as a TWITTER feed, or other type of external event. The collaborative content that is made by individual users is synchronously stored with all of the resources from the original contents of a media archive. Collaborative additions appear in subsequent views/playbacks of the media archive presentation.

### Example Use Cases

There are numerous uses cases that provide advantageous features and functions based on the disclosed systems and methods.

In one embodiment, the disclosed systems can be configured to transmit an invitation to other individuals that are currently viewing the same presentation. The invitation will be an offer to collaborate and re-synch the view of the presentation from the beginning, or from any other agreed upon synchronized point in the presentation. The collaboration will be via chat windows and the subsequent comments will be synchronized and optionally stored and appended to the original synchronized body of work. This augmented chat window will be displayed whenever individuals subsequently view the same presentation and thereby assist others since the collaborative body of knowledge is supplemented, persisted, and shared. Note that the entire contents of the original and supplemental chat windows are searchable to the typed word/phrase.

A viewer of the presentation may get an alert event that another user has made a change to the presentation. The viewer then has the option to replay the presentation in its entirety or replay from the synchronized point in the presentation where the comment/question/correction was made.

The following use case is an example of a “live interrupt event.” A sales representative may be viewing the playback of a presentation with a client. A very technical question may arise that the sales representative cannot answer. The sales representative pauses the presentation and then sends a message to an engineer (or other subject matter expert). The content from the live chat with the subject matter expert is then inserted at that point in the original presentation and is persisted. These persisted additional comments are now available for all future views of the presentation. Note that from a user interface perspective, the dragging and dropping of the chat window directly into the playback/viewer may trigger the insertion of the new collaborative content into the media archive presentation.

In an embodiment, voice capture is obtained (e.g., from a phone call from a subject matter expert) and the audio clip recorded and synchronously added as a user note to the media archive. Optionally the auto transcript of the call can be synchronously inserted into the original presentation and persisted for future viewing.

User notes can be made via tweets (a kind of message used by TWITTER or similar messaging solutions). The user, if so desired, can use TWITTER to send a user note to a presentation, in that way others following the individual on TWITTER are also instantaneously made aware of the new updates made to the content of a media archive. In general, the user can use any commenting, blogging, or messaging system to send a user note to a presentation or any collaboration session, for example, via text messaging using short message service (SMS).

In an embodiment, portions of a presentation are associated with tags. Various types of tags may be associated with a presentation. Each type of tag may be associated with particular semantics. For example, high-level significant events from a presentation may be tagged for use by people interested in the content at a high-level. Low level technical details may be skipped for these users. Similarly, a tag may be associated with people interested in low level-technical details. Marketing and sales details may be skipped for these users. Similarly, a tag may be associated with marketing information and accordingly portions of presentation related to marketing are tagged appropriately, skipping low-level engineering details. The tags may be used, for example, for extracting relevant portions of the presentation and all associated user notes and synchronized media archives for a particular type of audience. For example, portions of the presentation, user notes and other related interactions of interest to marketing people may be extracted, creating a set of slices of the various media archive files of particular interest to the marketing people.

Subsequently, user notes added to portions of media resources with tags associated with particular users are identified. The users associated with the tags are informed of any changes, additions to the portions of presentation of interest to the users. For example, if an expert adds comments to a technical slide showing source code in a MICROSOFT POWERPOINT or APPLE KEYNOTE presentation, only the engineering users may be informed of the addition and the marketing and sales people may not be informed. Similarly, people interested in only high-level content may not be informed if the details added are related to a very specific detail that is not of interest to the general audience. Information from multiple presentations can be combined for use by specific types of audience. For example, a conference may have several presentations. All portions of the different presentations of interest to a general audience (or for example, specific types of audience) may be tagged. The relevant portions may be extracted and presented to specific types of audience. Similarly user notes added to a portion of any presentation of the conference that is tagged results in a notification message being sent to a user associated with that tag.

Following use cases further illustrate benefits of features discussed herein, for example, user notes. Many large companies have global service centers with service desks that span the entire globe. These distinct service centers can take advantage of the collaborative aspects described herein by both generating and viewing collaborative user notes on specific service problems that have been added elsewhere throughout the global enterprise. Thus, the collaborative sharing of user notes on specific topics of interest will improve overall knowledge of the services organization.

Another use case allows addition of legal notices, reminders, and disclaimers to collaboration sessions. In this use case consider that an existing set of digital media resources exists for a given company. Consider a situation in which the original company is acquired by another larger company. The legal staff for the larger company can utilize the event based collaboration capabilities disclosed herein to synchronously insert new Legal notices regarding the merger of the two companies at strategic points and/or time intervals in the presentation. Similarly, the legal staff could utilize the collaborative event capabilities described herein to insert “reminders” about company confidential materials at timed intervals through the presentation. Note that other synchronous media resources could also be synchronously updated, e.g., the POWERPOINT slides, transcripts, video, etc.

### Computing Machine Architecture

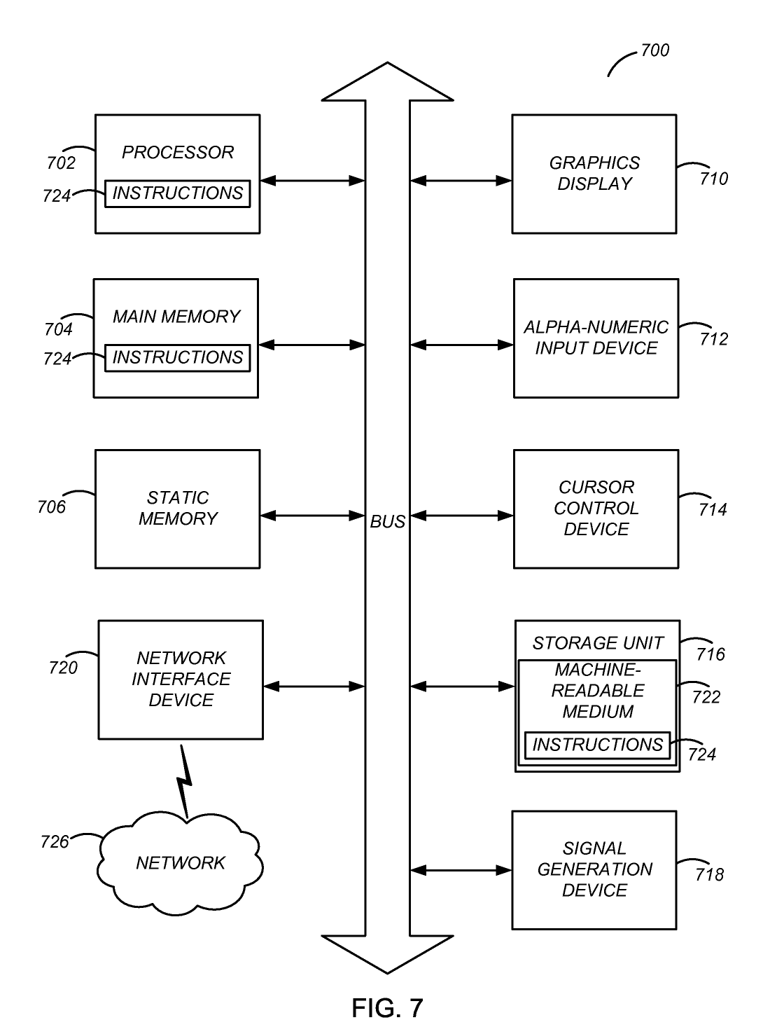

In the example disclosed systems and processes are structured to operate with machines to provide such machines with particular functionality as disclosed herein. FIG. 7 is a block diagram illustrating components of an example machine configured to read instructions from a machine-readable medium and execute them through one or more processors (or one or more controllers). Specifically, FIG. 7 shows a diagrammatic representation of a machine in the example form of a computer system 700 within which instructions 724 (e.g., software cause the machine to perform any one or more of the methodologies discussed her when those instructions are executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

It is noted that the processes described herein, for example, with respect to FIGS. 3 and 5 may be embodied as functional instructions, e.g., 724, that are stored in a storage unit 716 within a machine-readable storage medium 722 and/or a main memory 704. Further, these instructions are executable by the processor 702. In addition, the functional elements described with FIGS. 1 and 2 also may be embodied as instructions that are stored in the storage unit 716 and/or the main memory 704. Moreover, when these instructions are executed by the processor 702, they cause the processor to perform operations in the particular manner in which the functionality is configured by the instructions.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these, a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion') as a hardware module that operates to perform certain operations as described herein, for example, the process illustrated and described with respect to, for example, FIGS. 3 and 5.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein a be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the internal and via one or more appropriate interfaces application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, nonvolatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a method for processing of user notes for media archive resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer implemented method of playback of information stored as a media archive, the method comprising:
receiving a request for playback of a portion of a media archive comprising a plurality of media resources synchronized with each other and a plurality of user notes, each user note associated with a position in a media resource, the media archive comprising a first media resource correlated with a second media resource, the correlation comprising:
identifying a first sequence of patterns in the first media resource and a second sequence of patterns in the second media resource, and
correlating elements of the first sequence with elements of the second sequence;
identifying a first position of the first media resource and a second position of the second media resource, wherein the first position and the second position correspond to correlated elements of the first sequence and the second sequence;
presenting the first media resource starting from the first position simultaneously with the second media resource starting from the second position; and
presenting a user note responsive to the user note being associated with at least one of the first media resource at a position occurring after the first position or with the second media resource at a position occurring after the second position.

2. The computer implemented method of claim 1, further comprising:
identifying a first end position of the first media resource and a second end position of the second media resource synchronized with the first position of the first media resource; and
stopping the presentation of the first media resource and the second media resource subsequent to playback of one of the first end position of the first media resource or the second end position of the second media resource.

3. The computer implemented method of claim 1, further comprising:
receiving a subscription request, the subscription request describing an occurrence of an event associated with the playback of the media archive; and
responsive to the occurrence of the event, sending a notification message to the subscriber of the subscription request.

4. The computer implemented method of claim 3, wherein the event comprises a user joining a collaboration session for viewing the playback of the media archive.

5. The computer implemented method of claim 3, wherein the event comprises a search term occurring in at least one of the first media resource at a position after the first position or the second media resource at a position after the second position.

6. The computer implemented method of claim 3, wherein the event comprises recognizing a user by voice in a portion of at least one of the first media resource at a position after the first position or the second media resource at a position after the second position.

7. The computer implemented method of claim 1, further comprising:
sending a message informing one or more users about the playback of the portion of the media archive.

8. The computer implemented method of claim 1, wherein each user note comprises a media resource.

9. The computer implemented method of claim 1, further comprising:
receiving a criteria for filtering user notes, wherein a user note is presented responsive to satisfying the criteria.

10. The computer implemented method of claim 9, wherein the criteria for filtering user notes specifies information identifying a user providing the note.

11. The computer implemented method of claim 9, wherein the criteria for filtering user notes specifies information describing content of a user note.

12. The computer implemented method of claim 9, wherein the criteria for filtering user notes specifics a media format of the user note.

13. The computer implemented method of claim 9, wherein the criteria for filtering user notes specifies a time range during which a user note was added.

14. The computer implemented method of claim 9, wherein the criteria, for filtering user notes specifies a geographical region associated with a user adding the user note.

15. The computer implemented method of claim 1, wherein presenting the user note is responsive to the user note matching information associated with a user that requested presentation of the user note.

16. The computer implemented method of claim 15, wherein matching the user note with the user comprises comparing information described in the user note with a preference associated with the user.

17. The computer implemented method of claim 15, wherein matching the user note with the user comprises comparing an attribute associated with the media archive describing the target audience for the media archive with information describing the user.

18. The computer implemented method of claim 15, wherein matching the user note with the user comprises comparing categories of users associated with the media archive with categories of users associated with the user.

19. The computer implemented method of claim 1, wherein presenting the user note is responsive to determining that the user has permission to access the user note.

20. A computer implemented method of extraction of information stored as a media archive, the method comprising:
receiving a request for extracting a portion of a media archive comprising a plurality of media resource synchronized with each other, comprising a first media resource correlated with a second media resource, the correlation comprising:
identifying a sequence of patterns in each media resource, and
correlating elements of the sequence of each media resource with elements of the sequence of at least one other media resource;
identifying a start position of each media resource such that each start position is associated with an element, the associated elements being correlated with each other; and
storing an extracted media archive comprising a portion of each media resource starting from the start position of the corresponding media resource.

21. The computer implemented method of claim 20, wherein the media archive comprises user notes such that each user note is associated with at least one media resource of the media archive and a position of the media resource, the method further comprising:
storing a user note along with the extracted media archive responsive to determining that the position associated with the user note is after the start position of the associated media resource.

22. The computer implemented method of claim 20, wherein each user note comprises a media resource.

23. The computer implemented method of claim 20, further comprising:
identifying an end position for each media resource for the playback; and
wherein the extracted media archive comprises portions of media resources of the media archive occurring before the end positions of the corresponding media archive.

24. The computer implemented method of claim 20, further comprising:
sending a message informing one or more users about the extracted media archive.

25. The computer implemented method of claim 20, further comprising:
receiving a criteria for filtering user notes, wherein a user note is added to the extracted media archive responsive to satisfying the criteria.

26. The computer implemented method of claim 25, wherein the criteria for filtering user notes specifies information identifying a user providing the note.

27. The computer implemented method of claim 25, wherein the criteria for filtering user notes specifies information describing content of a user note.

28. The computer implemented method of claim 25, wherein the criteria for filtering user notes specifies a media format of the user note.

29. The computer implemented method of claim 25, wherein the criteria for filtering user notes specifies a time range during which a user note was added.

30. The computer implemented method of claim 25, wherein the criteria for filtering user notes specifies a geographical region associated with a user adding the user note.

31. A computer implemented method of redaction of information stored as a media archive, the method comprising:
receiving a request for redacting a portion of a media archive comprising a plurality of media resource synchronized with each other, comprising a first media resource correlated with a second media resource, the correlation comprising:
identifying a sequence of patterns in each media resource, and
correlating elements of the sequence of each media resource with elements of the sequence of at least one other media resource;
identifying a redacted portion of the media archive between a start position of the media archive and an end position of the media archive, wherein each position of media archive is associated with correlated elements of sequences of media resources;
receiving a request for presentation of one or more portions of the media archive wherein at least one portion overlaps with the redacted portion of the media archive; and
presenting information of the media resources of the media archive, wherein the presentation withholds the information in media resources within the redacted portion of the media archive.

32. The computer implemented method of claim 31, wherein the redacted portion of the media archive is associated with one or more users and the presentation withholds the information from a user responsive to determining that the user belongs to the one or more users.

33. The computer implemented method of claim 31, wherein the redacted portion of the mea archive is associated with a category of users and the presentation withholds the information from a user responsive to determining that the user is associated with the category of users.

34. The computer implemented method of claim 31, wherein the presentation further withholds user notes associated with positions within the start position and the end position.

35. A computer implemented system for playback of media resources of a media archive, the system comprising:
a computer processor; and
a computer-readable storage medium storing computer program modules configured to execute on the computer processor, the computer program modules comprising:
a universal media convertor module configured to:
receive a request for playback of a portion of a media archive comprising a plurality of media resources synchronized with each other and a plurality of user notes, each user note associated with a position in a media resource, the media archive comprising a first media resource correlated with a second media resource, the correlation comprising code configured to:
identify a first sequence of patterns in the first media resource and a second sequence of patterns in the second media resource; and
correlate elements of the first sequence with elements of the second sequence;
a universal media aggregator module configured to:
identify a first position of the first media resource and a second position of the second media resource, wherein the first position and the second position correspond to correlated elements of the first sequence and the second sequence;
present the first media resource starting from the first position simultaneously with the second media resource starting from the second position; and
present a user note responsive to the user note being associated with at least one of the first media resource at a position occurring after the first position or with the second media resource at a position occurring after the second position.

36. A computer program product having a computer-readable storage medium storing computer-executable code for augmenting a synchronized media archive with user notes, the code comprising:
a universal media convertor module configured to:
receive a request for playback of a portion of a media archive comprising a plurality of media resources synchronized with each other and a plurality of user notes, each user note associated with a position in a media resource, the media archive comprising a first media resource correlated with a second media resource, the correlation comprising code configured to:
identify a first sequence of patterns in the first media resource and a second sequence of patterns in the second media resource; and
correlate elements of the first sequence with elements of the second sequence;
a universal media aggregator module configured to:
identify a first position of the first media resource and a second position of the second media resource, wherein the first position and the second position correspond to correlated elements of the first sequence and the second sequence;
present the first media resource starting from the first position simultaneously with the second media resource starting from the second position; and
present a user note responsive to the user note being associated with at least one of the first media resource at a position occurring after the first position or with the second media resource at a position occurring after the second position.
